(19) United States
(12) Patent Application Publication
(10) Pub. No.: US 2020/0327468 A1
(43) Pub. Date: Oct. 15, 2020

(54) System, Method, and Computer Program Product for Optimizing a Parking Schedule, Increasing Parking Spot Utilization, Parking Lot Enforcement, and Parking Spot Reassignment

(71) Applicant: ParkStash, Inc., San Jose, CA (US)

(72) Inventors: Sameer Saran, San Jose, CA (US); Hooman Bolandi, Los Gatos, CA (US); Priya Dixit, San Jose, CA (US); Abhaya Uprety, Monroe, LA (US)

(21) Appl. No.: 16/849,400

(22) Filed: Apr. 15, 2020

Related U.S. Application Data
(60) Provisional application No. 62/834,207, filed on Apr. 15, 2019.

(51) Int. Cl. G06Q 10/06; G06Q 30/00; G06Q 10/02; G06K 9/00

(52) U.S. Cl. CPC G06Q 10/06312; G06Q 30/0185; G06K 2209/15; G06K 9/00771; G06Q 2240/00; G06Q 10/02

(57) ABSTRACT

Provided is a computer-implemented method for determining a parking schedule, including receiving, with at least one processor, data associated with a first parking schedule involving a first vehicle; generating, with at least one processor, a facility parking schedule based on the first parking schedule and one or more identifiers corresponding to one or more parking spaces in a parking garage; receiving, with at least one processor, a second parking schedule involving a second vehicle different from the first vehicle. Computer-implemented methods may also include determining, with at least one processor, whether a conflict exists based on the facility parking schedule and the second parking schedule. Systems and computer program products are also provided.

### CROSS-REFERENCE TO RELATED APPLICATIONS

This application claims priority to U.S. Provisional Patent Application No. 62/834,207, filed on Apr. 15, 2019, the contents of which are hereby incorporated by reference in their entirety.

### BACKGROUND

### 1. Field

This disclosure relates generally to optimizing a parking schedule and, in some non-limiting embodiments or aspects, to systems, methods, and computer program products for determining a parking schedule based on one or more parking schedules associated with one or more vehicles.

### 2. Technical Considerations

Individuals may reserve parking spaces at a facility such as a parking lot. For example, a plurality of individuals may interact with devices such as a laptop computers to generate reservation requests for reserving parking spaces at a parking lot on a particular day. The devices may then generate and transmit data associated with the reservation requests to a system for reserving parking spaces that manages the parking lot based on the interaction between the individuals and the devices. The system for reserving parking spaces may determine whether a parking space is available based on the system for reserving parking spaces determining a total number of reservations for the particular day and comparing the total number of reservations to a total number of parking spaces associated with the parking lot.

In response to the system for reserving parking spaces receiving data associated with reservation requests, for each reservation request, the system for reserving parking spaces may determine that the total number of reservation requests is less than or equal to the total number of parking spaces associated with the parking lot. In this example, the system may transmit data associated with confirming the reservation requests to the devices that transmitted the data associated with the reservation requests. Alternatively, the system for reserving parking spaces may determine that the total number of reservation requests is greater than the total number of parking spaces associated with the parking lot. In this example, the system may transmit data associated with not confirming (e.g., denying) the reservation requests to the devices that transmitted the data associated with the reservation requests.

However, the system for reserving parking spaces may transmit data associated with not confirming the reservation when the reservation request could otherwise be accommodated. For example, the system for reserving parking spaces may determine that there are no spaces available to satisfy a reservation request when one or more spaces are going to be available (e.g., where a reservation is going to end at a time before the beginning of the reservation request). This, in turn, may cause the individuals associated with the denied reservation request to repeat the above-described reservation process, thereby increasing the amount of network communication involved in reserving a parking space. For example, the individuals associated with the reservation requests that were denied may repeat the above-noted process for registration until a parking space becomes available, at which point the reservation requests may be satisfied.

### SUMMARY

Accordingly, disclosed are improved systems, methods, and computer program products for optimizing a parking schedule.

In some non-limiting embodiments or aspects, provided is a computer implemented method including: receiving, with at least one processor, data associated with a first parking schedule involving a first vehicle; generating, with at least one processor, a facility parking schedule based on the first parking schedule and one or more identifiers corresponding to one or more parking spaces in a parking garage; receiving, with at least one processor, data associated with a second parking schedule involving a second vehicle different from the first vehicle; comparing, with at least one processor, one or more times associated with the facility parking schedule that involve the first parking schedule with one or more times associated with the facility parking schedule that involve the second parking schedule; determining, with at least one processor, whether a conflict exists based on comparing the one or more times associated with the facility parking schedule that involve the first parking schedule with the one or more times associated with the facility parking schedule that involve the second parking schedule; and updating, with at least one processor, the facility parking schedule based on the conflict, wherein updating the facility parking schedule includes associating the first vehicle with an identifier corresponding to a parking space that is different from an identifier of a parking space that is associated with the first vehicle by the facility parking schedule.

In some non-limiting embodiments or aspects, provided is a system including at least one processor programmed or configured to: receive data associated with a first parking schedule involving a first vehicle; generate a facility parking schedule based on the first parking schedule and one or more identifiers corresponding to one or more parking spaces in a parking garage; receive data associated with a second parking schedule involving a second vehicle different from the first vehicle; and determine whether a conflict exists based on the facility parking schedule and the second parking schedule.

In some non-limiting embodiments or aspects, provided is a computer program product for processing a transaction, comprising at least one non-transitory computer-readable medium including program instructions that, when executed by at least one processor, cause the at least one processor to: receive data associated with a first parking schedule involving a first vehicle; generate a facility parking schedule based on the first parking schedule and one or more identifiers corresponding to one or more parking spaces in a parking garage; receive data associated with a second parking schedule involving a second vehicle different from the first vehicle; and determine whether a conflict exists based on the facility parking schedule and the second parking schedule.

Other non-limiting embodiments or aspects will be set forth in the following numbered clauses:

Clause 1: A computer-implemented method, comprising: receiving, with at least one processor, data associated with a first parking schedule involving a first vehicle; generating, with at least one processor, a facility parking schedule based on the first parking schedule and one or more identifiers corresponding to one or more parking spaces in a parking garage; receiving, with at least one processor, data associated with a second parking schedule involving a second vehicle different from the first vehicle; comparing, with at least one processor, one or more times associated with the facility parking schedule that involve the first parking schedule with one or more times associated with the facility parking schedule that involve the second parking schedule; determining, with at least one processor, whether a conflict exists based on comparing the one or more times associated with the facility parking schedule that involve the first parking schedule with the one or more times associated with the facility parking schedule that involve the second parking schedule; and updating, with at least one processor, the facility parking schedule based on the conflict, wherein updating the facility parking schedule includes associating the first vehicle with an identifier corresponding to a parking space that is different from an identifier of a parking space that is associated with the first vehicle by the facility parking schedule.

Clause 2: The computer-implemented method of clause 1, wherein determining whether a conflict exists based on the first parking schedule and the second parking schedule comprises: determining that one or more conflicts exist based on the first parking schedule and the second parking schedule, the method further comprising: generating data associated with a transaction based on the first parking schedule and the one or more conflicts that exist; and transmitting the data to initiate the transaction.

Clause 3: The computer-implemented method of clauses 1 or 2, further comprising: receiving data associated with an image of a license plate in a parking space; determining a license plate identifier based on the image of the license plate in the parking space using an image processing algorithm and a time at which the image of the license plate was captured; comparing the license plate identifier to one or more license plate identifiers associated with the facility parking schedule at the time at which the image of the license plate was captured; and determining whether a parking violation exists based on comparing the license plate identifier to the one or more license plate identifiers associated with the facility parking schedule at the time at which the image of the license plate was captured.

Clause 4: The computer-implemented method of any of clauses 1-3, wherein determining whether a parking violation exists based on comparing the license plate identifier to the one or more license plate identifiers associated with the facility parking schedule at the time at which the image of the license plate was captured comprises: determining that the parking violation exists based on comparing the license plate identifier to the one or more license plate identifiers associated with the facility parking schedule at the time at which the image of the license plate was captured, the method further comprising: transmitting data associated with a transaction generated based on the parking violation, the data associated with the transaction configured to cause a user device associated with the transaction to generate a display indicating that the transaction is pending.

Clause 5: The computer-implemented method of any of clauses 1-4, further comprising: determining that the first vehicle is parked in a parking space at a time other than a time specified by the first parking schedule; and generating data associated with a transaction based on determining that the first vehicle is parked in a parking space at a time other than a time specified by the first parking schedule, the data associated with the transaction configured to cause a user device associated with the transaction to generate a display indicating that the transaction is pending.

Clause 6: The computer-implemented method of any of clauses 1-5, further comprising: receiving data associated with an indication that a third vehicle is in a parking space associated with the first vehicle; determining a second parking space different from the parking space that the third vehicle is parked in; associating the second parking space with the first vehicle during a period of time; and transmitting data associated with an indication that the second parking space is associated with the first vehicle during the period of time, wherein the data associated with the indication that the second parking space is associated with the first vehicle during the period of time is configured to cause a user device associated with the first vehicle to generate a display including the indication that the second parking space is associated with the first vehicle during the period of time.

Clause 7: The computer-implemented method of any of clauses 1-6, further comprising: receiving data associated with an indication that a third vehicle is in a parking space associated with a first vehicle; determining that a parking violation exists based on the indication that the third vehicle is in the parking space associated with the first vehicle; and generating data associated with a transaction based on the parking violation.

Clause 8: A system, comprising: at least one processor programmed or configured to: receive data associated with a first parking schedule involving a first vehicle; generate a facility parking schedule based on the first parking schedule and one or more identifiers corresponding to one or more parking spaces in a parking garage; receive data associated with a second parking schedule involving a second vehicle different from the first vehicle; and determine whether a conflict exists based on the facility parking schedule and the second parking schedule.

Clause 9: The system of clause 8, wherein determining whether a conflict exists based on the facility parking schedule and the second parking schedule comprises: comparing one or more times associated with the facility parking schedule with one or more times associated with the second parking schedule to determine whether the conflict exists.

Clause 10: The system of clauses 8 or 9, wherein, when determining whether a conflict exists based on the first parking schedule and the second parking schedule, the at least one processor is programmed or configured to: determine that one or more conflicts exist based on the first parking schedule and the second parking schedule, wherein the at least one processor is further programmed or configured to: generate data associated with a transaction based on the first parking schedule and the one or more conflicts that exist; and transmit the data to initiate the transaction.

Clause 11: The system of any of clauses 8-10, wherein the at least one processor is further programmed or configured to: receive data associated with an image of a license plate in a parking space; determine a license plate identifier based on the image of the license plate in the parking space using an image processing algorithm and a time at which the image of the license plate was captured; compare the license plate identifier to one or more license plate identifiers associated with the facility parking schedule at the time at which the image of the license plate was captured; and determine whether a parking violation exists based on comparing the license plate identifier to the one or more license plate identifiers associated with the facility parking schedule at the time at which the image of the license plate was captured.

Clause 12: The system of any of clauses 8-11, wherein, when determining whether a parking violation exists based on comparing the license plate identifier to the one or more license plate identifiers associated with the facility parking schedule at the time at which the image of the license plate was captured, the at least one processor is programmed or configured to: determine that the parking violation exists based on comparing the license plate identifier to the one or more license plate identifiers associated with the facility parking schedule at the time at which the image of the license plate was captured, wherein the at least one processor is further programmed or configured to: transmit data associated with a transaction generated based on the parking violation, the data associated with the transaction configured to cause a user device associated with the transaction to generate a display indicating that the transaction is pending.

Clause 13: The system of any of clauses 8-12, wherein the at least one processor is further programmed or configured to: determine that the first vehicle is parked in a parking space at a time other than a time specified by the first parking schedule; and generate data associated with a transaction based on determining that the first vehicle is parked in a parking space at a time other than a time specified by the first parking schedule, the data associated with the transaction configured to cause a user device associated with the transaction to generate a display indicating that the transaction is pending.

Clause 14: The system of any of clauses 8-13, wherein the at least one processor is further programmed or configured to: receive data associated with an indication that a third vehicle is in a parking space associated with the first vehicle; determine a second parking space different from the parking space that the third vehicle is parked in; associate the second parking space with the first vehicle during a period of time; and transmit data associated with an indication that the second parking space is associated with the first vehicle during the period of time, wherein the data associated with the indication that the second parking space is associated with the first vehicle during the period of time is configured to cause a user device associated with the first vehicle to generate a display including the indication that the second parking space is associated with the first vehicle during the period of time.

Clause 15: A computer program product, comprising at least one non-transitory computer-readable medium including program instructions that, when executed by at least one processor, cause the at least one processor to: receive data associated with a first parking schedule involving a first vehicle; generate a facility parking schedule based on the first parking schedule and one or more identifiers corresponding to one or more parking spaces in a parking garage; receive data associated with a second parking schedule involving a second vehicle different from the first vehicle; and determine whether a conflict exists based on the facility parking schedule and the second parking schedule.

Clause 16: The computer program product of clause 15, wherein the one or more instructions that cause the at least one processor to determine whether a conflict exists based on the facility parking schedule and the second parking schedule cause the at least one processor to: compare one or more times associated with the facility parking schedule with one or more times associated with the second parking schedule to determine whether the conflict exists.

Clause 17: The computer program product of clauses 15 or 16, wherein the one or more instructions that cause the at least one processor to determine whether a conflict exists based on the first parking schedule and the second parking schedule cause the at least one processor to: determine that one or more conflicts exist based on the first parking schedule and the second parking schedule, wherein the one or more instructions further cause the at least one processor to: generate data associated with a transaction based on the first parking schedule and the one or more conflicts that exist; and transmit the data to initiate the transaction.

Clause 18: The computer program product of any of clauses 15-17, wherein the one or more instructions further cause the at least one processor to: receive data associated with an image of a license plate in a parking space; determine a license plate identifier based on the image of the license plate in the parking space using an image processing algorithm and a time at which the image of the license plate was captured; compare the license plate identifier to one or more license plate identifiers associated with the facility parking schedule at the time at which the image of the license plate was captured; and determine whether a parking violation exists based on comparing the license plate identifier to the one or more license plate identifiers associated with the facility parking schedule at the time at which the image of the license plate was captured.

Clause 19: The computer program product of any of clauses 15-18, wherein the one or more instructions that cause the at least one processor to determine whether a parking violation exists based on comparing the license plate identifier to the one or more license plate identifiers associated with the facility parking schedule at the time at which the image of the license plate was captured cause the at least one processor to: determine that the parking violation exists based on comparing the license plate identifier to the one or more license plate identifiers associated with the facility parking schedule at the time at which the image of the license plate was captured, wherein the one or more instructions further cause the at least one processor to: transmit data associated with a transaction generated based on the parking violation, the data associated with the transaction configured to cause a user device associated with the transaction to generate a display indicating that the transaction is pending.

Clause 20: The computer program product of any of clauses 15-19, wherein the one or more instructions further cause the at least one processor to: determine that the first vehicle is parked in a parking space at a time other than a time specified by the first parking schedule; and generate data associated with a transaction based on determining that the first vehicle is parked in a parking space at a time other than a time specified by the first parking schedule, the data associated with the transaction configured to cause a user device associated with the transaction to generate a display indicating that the transaction is pending.

The features and characteristics of the present disclosure, as well as the methods of operation and functions of the related elements of structures and the combination of parts and economies of manufacture, will become more apparent upon consideration of the following description with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification, the singular form of “a,” “an,” and “the” include plural referents unless the context clearly dictates otherwise.

### BRIEF DESCRIPTION OF THE DRAWINGS

Additional advantages and details are explained in greater detail below with reference to the non-limiting, exemplary embodiments that are illustrated in the accompanying figures, in which:

FIG. 1 is a diagram of non-limiting embodiments or aspects of an environment in which systems, devices, products, apparatus, and/or methods, described herein, may be implemented;

FIG. 2 is a diagram of non-limiting embodiments or aspects of components of one or more devices and/or one or more systems of FIG. 1;

FIG. 3 is a flowchart of non-limiting embodiments or aspects of a process for determining a parking schedule; and

FIGS. 4A-4J are flowcharts of non-limiting embodiments or aspects of a process for determining a parking schedule.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments or aspects, a message may refer to a network packet (e.g., a data packet and/or the like) that includes data.

As used herein, the term “server” may refer to one or more devices, such as processors, storage devices, and/or similar computer components that communicate with client devices and/or other devices over a network, such as the Internet or private networks and, in some examples, facilitate communication among other servers and/or client devices.

As used herein, the term “system” may refer to one or more devices or combinations of devices such as, but not limited to, processors, servers, client devices, software applications, and/or other like components. In addition, reference to “a server” or “a processor,” as used herein, may refer to a previously-recited server and/or processor recited as performing a previous step or function, a different server and/or processor, and/or a combination of servers and/or processors. For example, as used in the specification and the claims, a first server and/or a first processor that are recited as performing a first step or function may refer to the same or different server and/or a processor recited as performing a second step or function.

As used herein, the term “supervised learning” may refer to one or more machine learning algorithms that start with known input variables (x) and output variables (y), and learn the mapping function from the input to the output. The goal of supervised learning is to approximate the mapping function so that predictions can be made about new input variables (x) that can be used to predict the output variables (y) for that data. The process of a supervised algorithm learning from the training dataset can be thought of as a teacher supervising the learning process. The correct answers are known. The algorithm iteratively makes predictions on the training data and is corrected by the teacher. Learning stops when the algorithm achieves an acceptable level of performance. Supervised learning problems can be further grouped into regression problems and classification problems. Supervised learning techniques can use labeled (e.g., classified) training data with normal and outlier data, but are not as reliable because of the lack of labeled outlier data. For example, multivariate probability distribution based systems are likely to score the data points with lower probabilities as outliers. A regression problem is when the output variable is a real value, such as “dollars” or “weight”. A classification problem is when the output variable is a category, such as “red” and “blue,” or “compliant” and “non-compliant”.

As used herein, the term “unsupervised learning” may refer to an algorithm which has input variables (x) and no corresponding output variables. The goal for unsupervised learning is to model the underlying structure or distribution in the data in order to learn more about the data. Unlike supervised learning, in unsupervised learning there are no correct answers and there is no teacher. Unsupervised learning algorithms are used to discover and present the interesting structure in the data. Unsupervised learning problems can be further grouped into clustering and association problems. A clustering problem is modeling used to discover the inherent groupings in a dataset, such as grouping customers by purchasing behavior. An association rule learning problem is where you want to discover rules that describe large portions of data, such as people that have condition A also tend to have condition B. Some examples of unsupervised learning algorithms are clustering and likelihood modeling.

As used herein, the term “training” may refer to a process of analyzing training data to generate a model (e.g., create a machine learning algorithm, a prediction model, a classification model, a segmentation model, etc.). For example, a training server uses machine learning techniques to analyze the training data to generate the model, often the training data includes numerous examples so that a robust model is generated to solve a problem for many variations present in the data. In some non-limiting embodiments or aspects, generating the model (e.g., based on training data from a variety of sources) is referred to as “training the model.” The machine learning techniques include, for example, supervised and/or unsupervised techniques, such as decision trees (e.g., gradient boosted decision trees), bootstrapped random forests, logistic regressions, artificial neural networks (e.g., convolutional neural networks), Bayesian statistics, learning automata, Hidden Markov Modeling, linear classifiers, quadratic classifiers, association rule learning, and/or the like.

In some non-limiting embodiments or aspects, a machine learning inference engine executes a model algorithm and returns an inference output. For example, an inference engine (e.g., inference server, etc.) may utilize one or more processing units (e.g., central processing unit (CPU), general processing unit (GPU), tensor processing unit (TPU), field programmable gateway array (FPGA), application-specific integrated circuit (ASIC), etc.) to execute the model algorithm, significant impact on speed, throughput, latency, accuracy, energy efficiency, and rate of learning. As an example, GPUs are designed to provide high throughput for massively parallelizable workloads (e.g., thousands of cores). GPUs are well-suited for machine learning, such as deep neural nets which consist of a large number of operators, each working on some input (e.g., tensor(s), etc.) that can be divided into smaller workloads and carried out in parallel, typically resulting in lower latency. GPUs carry out computations in a very efficient and optimized way, so that they consume less power and generate less heat than when the same task is run on CPUs. CPUs have a high clock frequency, large amounts of RAM (e.g., in the 100 GB-10 TB range), and are typically fast to process individual inferences (e.g., individual inferences that are not parallelizable, etc.). GPUs may perform their computation with 16-bit or 32-bit floating point numbers and do not require quantization (e.g., a process of constraining, such as rounding an input from a continuous or otherwise large set of values, such as the real numbers, to a discrete set, such as the integers which also may reduce accuracy and/or precision due to the number and complexity of mathematical calculations) during deep network processing for optimal performance.

Provided are improved systems, methods, and computer program products for determining a parking schedule. In some non-limiting embodiments or aspects, systems, methods, and computer program products described herein may include receiving, with at least one processor, data associated with a first parking schedule involving a first vehicle; generating, with at least one processor, a facility parking schedule based on the first parking schedule and one or more identifiers corresponding to one or more parking spaces in a parking garage; receiving, with at least one processor, data associated with a second parking schedule involving a second vehicle different from the first vehicle; and determining, with at least one processor, whether a conflict exists based on the facility parking schedule and the second parking schedule.

By virtue of the implementation of the systems, methods, and computer program products described herein, a parking management system may transmit data confirming a reservation request. For example, the parking management system may determine that there are spaces available to satisfy the reservation request based on the parking management system determining that the reservation request begins at a point in time after an earlier point in time at which a different reservation request ended. This, in turn, may reduce network communications between a user device of the individual associated with the reservation request and the parking management system by enabling the individual to forego repeating the above-described reservation process at a later time to reserving a parking space. For example, the individual associated with the reservation request may not need to repeat the registration process one or more times until a parking space becomes available, thereby reducing network communication as well as processing resources both at the user device and at the parking management system.

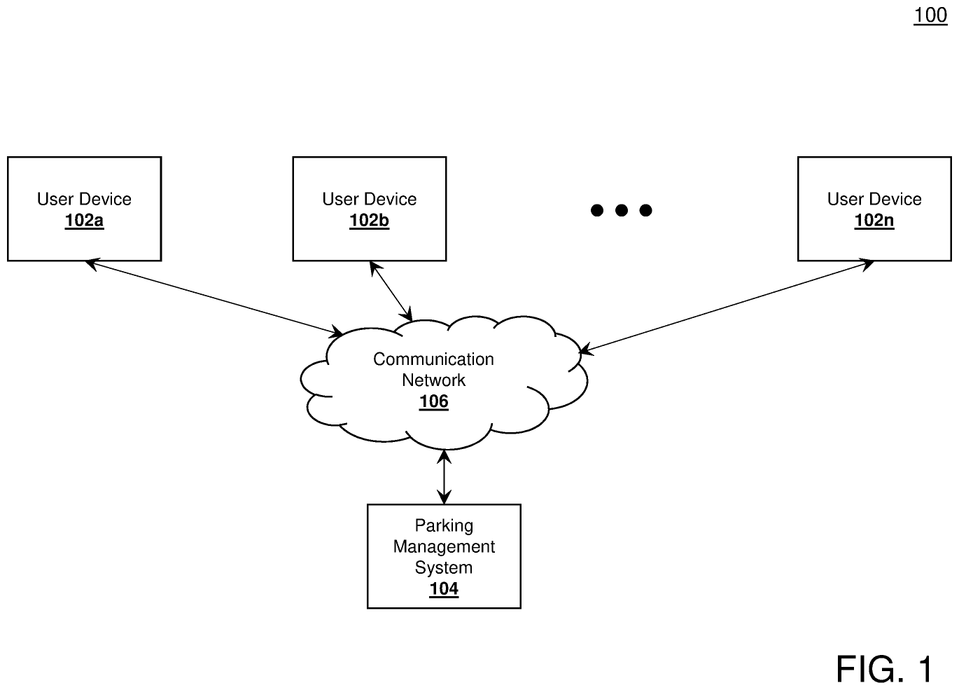

Referring now to FIG. 1, FIG. 1 is a diagram of an example environment 100 in which devices, systems, methods, and/or products described herein may be implemented. As shown in FIG. 1, environment 100 includes user devices 102a-102n (referred to collectively as “user devices 102” and individually as “user device 102”), parking management system 104, and communication network 106. In some non-limiting embodiments or aspects, user devices 102, parking management system 104, and/or communication network 106 may interconnect (e.g., establish a connection to communicate and/or the like) via wired connections, wireless connections, or a combination of wired and wireless connections.

User devices 102 may include a device configured to be in communication with other user devices 102 and/or parking management system 104 via communication network 106. For example, user devices 102 may include one or more devices such as a mobile device (e.g., a smartphone, a tablet, a laptop computer, and/or the like), a desktop computer, and/or the like. In some non-limiting embodiments or aspects, user devices 102 may be associated with users (e.g., individuals associated with one or more vehicles).

Parking management system 104 may include a device configured to be in communication with user devices 102 via communication network 106. For example, parking management system 104 may include one or more devices such as a server, a group of servers, and/or the like. In some non-limiting embodiments or aspects, parking management system 104 may be associated with an entity managing one or more parking spaces at one or more parking facilities (e.g., one or more parking lots, parking garages, street spaces, and/or the like).

Communication network 106 may include one or more wired and/or wireless networks. For example, communication network 106 may include a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of some or all of these or other types of networks.

The number and arrangement of systems and/or devices shown in FIG. 1 are provided as an example. There may be additional systems and/or devices, fewer systems and/or devices, different systems and/or devices, or differently arranged systems and/or devices than those shown in FIG. 1. Furthermore, two or more systems and/or devices shown in FIG. 1 may be implemented within a single system or a single device, or a single system or a single device shown in FIG. 1 may be implemented as multiple, distributed systems or devices. Additionally, or alternatively, a set of systems or a set of devices (e.g., one or more systems, one or more devices) of environment 100 may perform one or more functions described as being performed by another set of systems or another set of devices of environment 100.

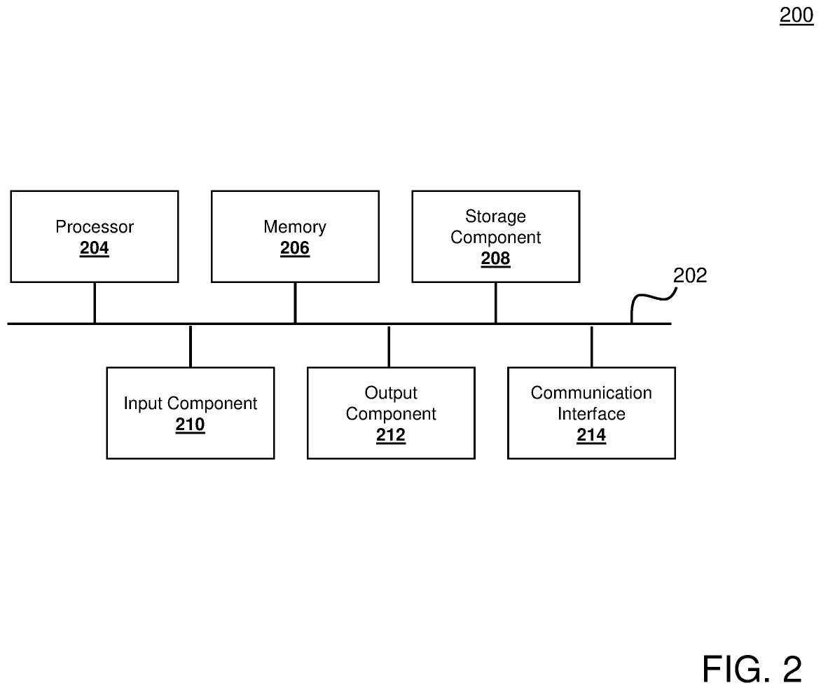

Referring now to FIG. 2, illustrated is a diagram of example components of device 200. Device 200 may correspond to one or more devices of user devices 102 (e.g., one or more devices of a system of user devices 102), one or more devices of parking management system 104 (e.g., one or more devices of a system of parking management system 104), and/or one or more devices of the communication network 106 (e.g., one or more devices of a system of communication network 106). In some non-limiting embodiments or aspects, one or more devices of user devices 102, one or more devices of parking management system 104, and/or one or more devices of communication network 106 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touchscreen display, a keyboard, a keypad, a mouse, a button, a switch, a microphone, a camera, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a WiFi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database, and/or the like). Device 200 may be capable of receiving information from, storing information in, communicating information to, or searching information stored in the data storage or one or more data structures in memory 206 and/or storage component 208. For example, the information may include input data, output data, or any combination thereof.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

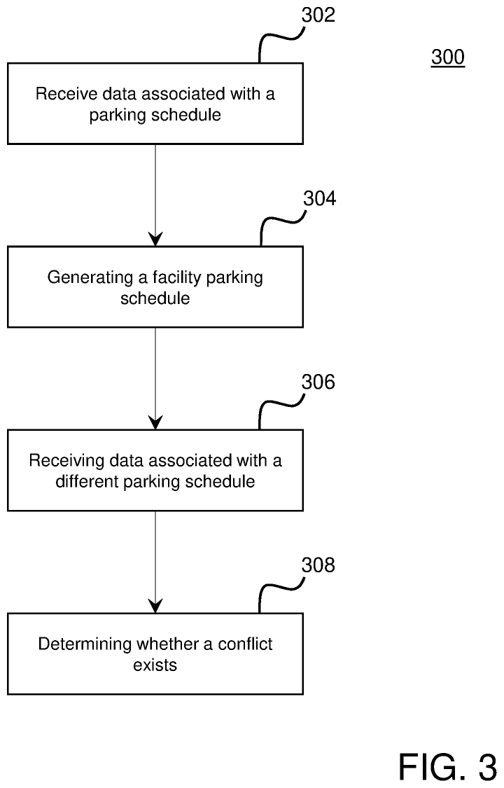

Referring now to FIG. 3, FIG. 3 is a flowchart of a non-limiting aspect or embodiment of a process 300 for determining a parking schedule. In some non-limiting embodiments or aspects, one or more of the functions described with respect to process 300 may be performed (e.g., completely, partially, and/or the like) by parking management system 104. In some non-limiting embodiments or aspects, one or more steps of process 300 may be performed (e.g., completely, partially, and/or the like) by another device or a group of devices separate from and/or including user devices 102.

As shown in FIG. 3, at step 302, process 300 may include receiving data associated with a parking schedule. For example, parking management system 104 may receive data associated with a parking schedule. In such an example, the parking schedule may be associated with a vehicle (e.g., a first vehicle). In some non-limiting embodiments or aspects, parking management system 104 may receive the data associated with the parking schedule associated with the vehicle from user device 102. For example, parking management system 104 may receive the data associated with the parking schedule that is associated with the vehicle from user device 102 where user device 102 is associated with a user. The user may be associated with (e.g., rent, lease, own, and/or the like) the vehicle. In some non-limiting embodiments or aspects, the parking schedule associated with the vehicle may specify an identifier associated with (e.g., assigned to) the vehicle (e.g., a hang-tag number, a license plate number, and/or the like).

In some non-limiting embodiments or aspects, the parking schedule associated with the vehicle may specify one or more days (e.g., Monday, Monday and Wednesday, Monday through Friday, Monday through Friday during January, Monday through Friday during January and February, during an event (e.g., a football game), and/or the like) and one or more times (e.g., at 9:00 AM, from 9:00 AM to 5:00 PM, from 6:00 PM to 7:00 AM, and/or the like) on the one or more days that the user associated with user device 102 intends to reserve a parking space for the vehicle. In some non-limiting embodiments or aspects, parking management system 104 may receive data associated with a plurality of parking schedules associated with a plurality of vehicles, where the plurality of parking schedules are recurring (e.g., parking schedules that repeat daily, weekly, monthly, and/or the like), from user devices 102. For example, parking management system 104 may receive data associated with a plurality of parking schedules associated with a plurality of vehicles, where the plurality of parking schedules are recurring, from user devices 102, where each parking schedule associated with a vehicle that is recurring specifies one or more days and one or more times on the one or more days that the users associated with user devices 102 intend to reserve a parking space on, respectively. Additionally, or alternatively, the parking schedule associated with the vehicle may include a one-time parking schedule (e.g., a request to use a parking space during one days, a request to use a parking space during one or more days for a continuous period of time, and/or the like). In some non-limiting embodiments or aspects, each parking schedule may specify one or more locations. For example, each parking schedule may specify one or more locations of one or more facilities associated with (e.g., managed by) parking management system 104, as described herein. Additionally, or alternatively, parking management system 104 may determine a location. For example, the first parking schedule may specify an event, a location, and/or the like and parking management system 104 may determine a location (e.g., a location associated with an available parking space at a facility, described herein) based on the event, the location, and/or the like.

In some non-limiting embodiments or aspects, user device 102 may generate the data associated with the parking schedule that is associated with the vehicle. For example, user device 102 may generate the data associated with the parking schedule that is associated with the vehicle based on user device 102 receiving input via an input device (e.g., a keyboard and mouse, a touchscreen, and/or the like) associated with the parking schedule. In such an example, user device 102 may determine the parking schedule based on the input received via the input device. In some non-limiting embodiments or aspects, user device 102 may generate the data associated with the parking schedule that is associated with the vehicle, where the data associated with the parking schedule that is associated with the vehicle includes data associated with an identifier of the vehicle. For example, user device 102 may generate the data associated with the parking schedule that is associated with the vehicle, where the data associated with the parking schedule that is associated with the vehicle includes data associated with an identifier of the vehicle based on the input received by user device 102. In such an example, the input received by user device 102 may specify the identifier of the vehicle. In some non-limiting embodiments or aspects, the data associated with the parking schedule that is associated with the vehicle may also include payment data associated with information for processing one or more transactions (e.g., a bank identification number associated with the user corresponding to user device 102, a credit card number associated with the user corresponding to user device 102, a debit card number associated with the user corresponding to user device 102, and/or the like) that are described herein.

As shown in FIG. 3, at step 304, process 300 may include generating a facility parking schedule. For example, parking management system 104 may generate a facility parking schedule. In some non-limiting embodiments or aspects, the facility parking schedule may specify one or more times during which a vehicle may be associated with (e.g., parked in) a parking space that is associated with an identifier, the parking space located at a facility (e.g., a parking lot, a parking garage, a street, and/or the like). In some non-limiting embodiments or aspects, the facility parking schedule may specify one or more times during which a plurality of vehicles may be parked in a plurality of parking spaces that are associated with a plurality of identifiers, respectively. For example, the facility parking schedule may specify one or more times during which a plurality of vehicles may be parked in a plurality of parking spaces that are associated with a plurality of identifiers (e.g., a single parking space associated with an identifier, a parking space associated with an identifier from among a plurality of parking spaces respectively associated with a plurality of identifiers, and/or the like), respectively. Each parking space may correspond to an identifier (e.g., a unique identifier such as a serial number and/or the like). In this example, the plurality of parking spaces may be included at a plurality of parking spaces at a single facility or a plurality of parking spaces at a plurality of facilities.

In some non-limiting embodiments or aspects, parking management system 104 may generate the facility parking schedule based on data associated with a parking schedule that is associated with a vehicle. For example, parking management system 104 may generate the facility parking schedule based on the data associated with the parking schedule that is associated with the vehicle, the data received from user device 102. Additionally, or alternatively, parking management system 104 may generate the facility parking schedule based on data associated with a plurality of parking schedules that are associated with a plurality of vehicles, respectively. For example, parking management system 104 may generate the facility parking schedule based on parking management system 104 receiving data associated with a plurality of parking schedules that are associated with a plurality of vehicles from user devices 102, respectively. In such an example, parking management system 104 may generate the facility parking schedule based on parking management system 104 receiving the data associated with the plurality of parking schedules that are associated with the plurality of vehicles, respectively from a plurality of corresponding user devices 102. In some non-limiting embodiments or aspects, the facility parking schedule may specify one or more parking assignments. For example, the facility parking schedule may specify one or more parking assignments, where each parking assignment includes (e.g., represents) the association of a vehicle (e.g., an identifier associated with a vehicle) with a parking space (e.g., with an identifier corresponding to a parking space). Each parking assignment may also include (e.g., specify) a time during which the vehicle is associated with the parking space.

In some non-limiting embodiments or aspects, parking management system 104 may generate data associated with a parking assignment. For example, parking management system 104 may generate data associated with a parking assignment corresponding to user device 102 that is associated with a user. In some non-limiting embodiments or aspects, the data associated with the parking assignment may be configured to cause user device 102 associated with the user to display the parking assignment (e.g., an identifier of a parking space assigned to the vehicle, a time during which the parking space is associated with the vehicle, and/or the like). For example, data associated with the parking assignment may be configured to cause user device 102 associated with the user to display an identifier of a parking space assigned to the vehicle associated with user device 102 and/or an identifier of the time that the parking space is assigned to the vehicle associated with user device 102.

In some non-limiting embodiments or aspects, where parking management system 104 determines that a conflict exists in the facility parking schedule (as described herein), parking management system 104 may update one or more parking assignments associated with one or more vehicles. For example, where user device 102 associated with a first vehicle transmits data associated with a parking schedule associated with the first vehicle to reserve a first parking space during a first time and user device 102 associated with a second vehicle transmits data associated with a parking schedule associated with the second vehicle reserves the first parking space during the first time, parking management system 104 may determine that a conflict exists and parking management system 104 may update the facility parking schedule by associating the first vehicle or the second vehicle with a second parking space different from the first parking space. In such an example, parking management system 104 may associate the identifier of the first vehicle or the identifier of the second vehicle with an identifier of the second parking space.

In some non-limiting embodiments or aspects, parking management system 104 may store data associated with the facility parking schedule and/or one or more parking schedules associated with one or more vehicles in a data structure. For example, parking management system 104 may store data associated with the facility parking schedule and/or one or more parking schedules involving one or more vehicles as objects in a data structure such as a database, a linked list, a hash map, an array, a set, and/or the like. In some non-limiting embodiments or aspects, the facility parking schedule may include a listing of parking space identifiers associated with the facility. Additionally, or alternatively, the facility parking schedule may specify one or more times (e.g., one or more pairs times at which a parking schedule starts and ends, one or more periods of time associated with a time buffer to be maintained between times associated with parking schedules included in the facility parking schedule, one or more times associated with a time buffer to be maintained between parking schedules included in the facility parking schedule where the parking schedules may be associated with a conflict, and/or the like). In some non-limiting embodiments or aspects, parking management system 104 may determine whether a parking space is available at a time. For example, parking management system 104 may determine whether a parking space is available at a time based on parking management system 104 determining a query specifying the parking space and the time (e.g., a point in time associated with the beginning of a parking schedule). In such an example, parking management system 104 may compare the query to the facility parking schedule and parking management system 104 may determine whether the parking space is available based on parking management system 104 comparing the query to the facility parking schedule. In some non-limiting embodiments or aspects, parking management system 104 may determine whether a parking space is involved in a parking schedule at a time that includes one or more hours. In some non-limiting embodiments or aspects, parking management system 104 may determine whether a parking space is involved in a parking schedule at a time that includes one or more hours that repeat during one or more weeks and/or one or more months.

In some non-limiting embodiments or aspects, parking management system 104 may associate a vehicle with a parking space based on parking management system 104 determining whether the parking schedule associated with the vehicle is associated with one or more times. For example, parking management system 104 may associate a vehicle with a parking space based on parking management system 104 determining whether the parking schedule associated with the vehicle specifies a time or a plurality of times. Where the parking schedule associated with the vehicle specifies a time, parking management system 104 may determine whether the parking space is associated with a parking schedule associated with a different vehicle during that time. Additionally, or alternatively, where the parking schedule associated with the vehicle specifies a plurality of times, parking management system 104 may determine whether the parking space is associated with a parking schedule associated with a different vehicle during that plurality of times. In such examples, parking management system 104 may determine whether the parking space is associated with a parking schedule associated with a different vehicle based on one or more of the identifiers associated with the parking space, the time specified by the parking schedule associated with the vehicle and/or the plurality of times specified by the parking schedule associated with the vehicle, and/or the like.

In some non-limiting embodiments or aspects, parking management system 104 may determine that the parking schedule associated with the vehicle is associated with one or more parking schedule types. For example, parking management system 104 may determine that the parking schedule associated with the vehicle is associated with one or more parking schedule types such as an inactive type (e.g., a type associated with a vehicle that has not been associated with a parking space for a time), an hourly type (e.g., a type associated with a vehicle that has been associated with a parking space for a time), a weekly type (e.g., a type associated with a vehicle that has been associated with a parking space for a plurality of days at a plurality of times), and/or the like. In some non-limiting embodiments or aspects, parking management system 104 may compare the one or more parking schedule types to one or more parking space types and parking management system 104 may associate the vehicle that is associated with the parking schedule based on the one or more parking schedule types and the one or more parking space types. In some non-limiting embodiments or aspects, the one or more parking space types may correspond to the one or more parking schedule types. For example, the one or more parking space types may include an inactive type (e.g., a type associated with a parking space that has not been associated with a vehicle for a time), an hourly type (e.g., a type associated with a parking space that has been associated with a vehicle for a time), a weekly type (e.g., a type associated with a parking space that has been associated with a vehicle for a plurality of days at a plurality of times), and/or the like.

In some non-limiting embodiments or aspects, parking management system 104 may determine a time during which a parking space is not involved in a parking schedule associated with a vehicle. For example, parking management system 104 may determine a time during which a parking space is not involved in a parking schedule associated with a vehicle based on parking management system 104 determining a query specifying a parking space identifier and a time. In such an example, parking management system 104 may determine the time during which the parking space is not involved in the parking schedule associated with a vehicle based on parking management system 104 comparing the query specifying the parking space identifier and the time to the facility parking schedule. In some non-limiting embodiments or aspects, parking management system 104 may determine a time during a plurality of weeks which a parking space is not involved in a parking schedule associated with a vehicle. For example, parking management system 104 may determine a time during a plurality of weeks which a parking space is not involved in a parking schedule associated with a vehicle based on parking management system 104 determining a query specifying a parking space identifier and a parking schedule associated with a different vehicle. In such an example, parking management system 104 may determine the time during the plurality of weeks which the parking space is not involved in the parking schedule associated with a vehicle based on parking management system 104 comparing the query specifying the parking space identifier and the time to the facility parking schedule. In some non-limiting embodiments or aspects, parking management system 104 may determine whether a parking space is available at a time using a search algorithm (e.g., a binary search tree).

In some non-limiting embodiments or aspects, parking management system 104 may receive data associated with a query associated with one or more parking spaces. For example, parking management system 104 may receive data associated with a query associated with one or more parking spaces based on user device 102 generating the data associated with the query and transmitting the data associated with the query to parking management system 104. In some non-limiting embodiments or aspects, the query associated with the one or more parking spaces may specify one or more identifiers of the one or more parking spaces and one or more times. In some non-limiting embodiments or aspects, parking management system 104 may compare the query associated with the one or more parking spaces to the facility parking schedule. For example, parking management system 104 may compare the query associated with the one or more parking spaces to the facility parking schedule and parking management system 104 may determine whether one or more parking spaces are available (e.g., are not associated with a vehicle) during the one or more times. In such an example, parking management system 104 may generate data associated with an indication of whether the one or more parking spaces are available during the one or more times and parking management system 104 may transmit the data associated with the indication of whether the one or more parking spaces are available during the one or more periods of time to user device 102. The data associated with the indication of whether the one or more parking spaces are available during the one or more periods of time may be configured to cause user device 102 to generate a display including the indication of whether the one or more parking spaces are available during the one or more periods of time. In some non-limiting embodiments or aspects, parking management system 104 may cache data associated with the indication of whether the one or more parking spaces are available during the one or more times and parking management system 104 may compare one or more queries received at a later time to the indication of whether the one or more parking spaces are available during the one or more times.

As shown in FIG. 3, at step 306, process 300 may include receiving data associated with a different parking schedule. For example, where the parking schedule associated with the vehicle is a parking schedule associated with a first vehicle, parking management system 104 may receive data associated with a parking schedule that is associate with a second vehicle. In some non-limiting embodiments or aspects, parking management system 104 may receive the data associated with the parking schedule that is associate with the second vehicle from user device 102. For example, parking management system 104 may receive the data associated with the parking schedule that is associate with the second vehicle from user device 102, where user device 102 is associated with a user (e.g., a second user). In some non-limiting embodiments or aspects, the parking schedule that is associate with the second vehicle may specify one or more days and one or more times on the one or more days that the user associated with user device 102 intends to reserve a parking space for the second, as described above.

In some non-limiting embodiments or aspects, parking management system 104 may update the facility parking schedule. For example, parking management system 104 may update the facility parking schedule based on the parking schedule that is associated with the first vehicle and/or the parking schedule that is associate with the second vehicle. In some non-limiting embodiments or aspects, parking management system 104 may update the facility parking schedule based on (e.g., during and/or after) parking management system 104 receiving the data associated with the parking schedule that is associate with the second vehicle. In some non-limiting embodiments or aspects, parking management system 104 may update the facility parking schedule based on parking management system 104 updating the one or more parking assignments associated with the one or more vehicles, as described herein.

As shown in FIG. 3, at step 308, process 300 may include determining whether a conflict exists. For example, parking management system 104 may determine whether a conflict exists. In some non-limiting embodiments or aspects, a conflict may be represented by a facility parking schedule in which two vehicles are assigned to the same parking space during the same date and time. For example, a conflict may include a parking schedule where the first vehicle associated with the first parking schedule is assigned to a parking space associated with a first identifier, and the second vehicle associated with the second parking schedule is assigned to the parking space associated with the first identifier. In such an example, the first vehicle and the second vehicle may be assigned to the parking space during a time that at least partially includes a time corresponding to the first parking schedule and a time corresponding to the second parking schedule.

In some non-limiting embodiments or aspects, parking management system 104 may determine that the conflict exists based on the parking schedule that is associated with the first vehicle and the parking schedule that is associated with the second vehicle. For example, parking management system 104 may determine that the conflict exists based on parking management system 104 comparing the parking schedule that is associated with the first vehicle and the parking schedule that is associate with the second vehicle. In some non-limiting embodiments or aspects, where parking management system 104 has not updated the facility parking schedule based on the parking schedule that is associate with the second vehicle, parking management system 104 may compare the parking schedule that is associated with the first vehicle and the parking schedule that is associate with the second vehicle based on parking management system 104 comparing one or more times associated with the facility parking schedule that correspond to the parking schedule that is associated with the first vehicle with one or more times associated with the parking schedule that is associate with the second vehicle to determine whether the conflict exists. For example, parking management system 104 may compare the one or more times associated with the facility parking schedule that correspond to the parking schedule that is associated with the first vehicle and the parking schedule that is associate with the second vehicle and parking management system 104 may determine a conflict exists where one or more times of the parking schedule that is associated with the first vehicle at least partially overlap with one or more times of the parking schedule that is associate with the second vehicle.

In some non-limiting embodiments or aspects, parking management system 104 may assign the second vehicle to a parking space having an identifier that is different from the identifier of the parking space assigned to the first vehicle. For example, parking management system 104 may assign the second vehicle associated with the parking schedule to a parking space having an identifier that is different from the identifier of the parking space assigned to the first vehicle based on parking management system 104 determining that a conflict exists. In some non-limiting embodiments or aspects, parking management system 104 may assign the second vehicle associated to a parking space that is the same as the parking space assigned to the first vehicle where parking management system 104 determines that a conflict does not exist. In some non-limiting embodiments or aspects, parking management system 104 may associate an identifier of a vehicle with an identifier of a parking space. For example, parking management system 104 may associate an identifier of a vehicle with an identifier of a parking space of a parking facility based on parking management system 104 generating and/or updating the facility parking schedule. Additionally, or alternatively, parking management system 104 may associate an identifier of a vehicle with an identifier of a parking space of a parking facility based on parking management system 104 determining that a conflict exists.

In some non-limiting embodiments or aspects, parking management system 104 may generate data associated with a transaction based on parking management system 104 determining that a conflict exists. For example, parking management system 104 may generate data associated with a transaction based on parking management system 104 determining that a conflict exists, where the transaction is associated with (e.g., includes) a fee. In such an example, the fee may be associated with parking management system 104 foregoing assigning the parking space to a vehicle involved in a conflict, as described herein. In some non-limiting embodiments or aspects, parking management system 104 may transmit the data associated with a transaction to user device 102 that is associated with a vehicle assigned to a parking space involved in the conflict. The data may be configured to cause user device 102 that is associated with the vehicle assigned to the parking space involved in the conflict to provide an output via a display prompting the user associated with user device 102 to accept or not accept the fee. In some non-limiting embodiments or aspects, user device 102 may receive input indicating whether the user accepts or does not accept the fee and user device 102 may generate and transmit data associated with the input indicating whether the user associated with user device 102 accepts or does not accept the fee. In some non-limiting embodiments or aspects, parking management system 104 may update the facility parking schedule based on the data associated with the input indicating whether the user associated with user device 102 accepts or does not accept the fee. For example, parking management system 104 may update the facility parking schedule based on the data associated with the input indicating whether the user associated with user device 102 does not accept the fee by reassigning the parking space to the other vehicle involved in the conflict.

In some non-limiting embodiments or aspects, parking management system 104 may receive data associated with an indication that a vehicle is in a parking space that is assigned to a different vehicle. For example, parking management system 104 may receive data associated with an indication that a third vehicle is in a parking space associated with the first vehicle. In some non-limiting embodiments or aspects, the data associated with the indication that the third vehicle is in the parking space that is associated with the first vehicle may include data associated with an image of a license plate of the vehicle that is in the parking space and/or an image of an identifier of the parking space. For example, user device 102 that is associated with the first vehicle may be used to capture an image of the license plate of the vehicle that is in the parking space while in the parking space and user device 102 may transmit the data associated with the image of the license plate to parking management system 104. In some non-limiting embodiments or aspects, parking management system 104 may determine a license plate identifier associated with a license plate. For example, parking management system 104 may determine a license plate identifier associated with the license plate and/or an identifier of the parking space based on parking management system 104 using an image processing technique (e.g., optical character recognition (OCR) and/or the like).

In some non-limiting embodiments or aspects, parking management system 104 may receive data associated with an image including one or more vehicles in one or more parking spaces. For example, parking management system 104 may receive data associated with an image including one or more vehicles in one or more parking spaces from user device 102. In some non-limiting embodiments or aspects, parking management system 104 may provide the image including the one or more vehicles in the one or more parking spaces as input to a machine learning model. For example, parking management system 104 may provide the image including the one or more vehicles in the one or more parking spaces as input to a machine learning model to generate one or more predictions. In such an example, the one or more predictions may specify one or more identifiers of one or more vehicles and/or one or more identifiers of one or more parking spaces corresponding to the one or more vehicles. In some non-limiting embodiments or aspects, parking management system 104 may determine that the facility parking schedule does not specify that the one or more identifiers of one or more vehicles are assigned to the one or more identifiers of one or more parking spaces. For example, parking management system 104 may determine that the facility parking schedule does not specify that the one or more identifiers of one or more vehicles are assigned to the one or more identifiers of one or more parking spaces based on parking management system 104 comparing the one or more identifiers of the one or more vehicles and/or the one or more identifiers of the one or more parking spaces to the facility parking schedule. In such an example, parking management system 104 may determine that a parking violation, as described herein, exists based on parking management system 104 comparing the one or more identifiers of the one or more vehicles and/or the one or more identifiers of the one or more parking spaces to the facility parking schedule. In some non-limiting embodiments or aspects, parking management system 104 may generate data associated with a transaction based on parking management system 104 determining that a parking violation exists. For example, parking management system 104 may generate data associated with a transaction based on parking management system 104 determining that a parking violation exists, where the transaction is associated with a credit for submitting an image involved in the determination that the parking violation exists. In such an example, the credit may be transferred to an account associated with user device 102 that submitted the image involved in the determination that the parking violation exists.

In some non-limiting embodiments or aspects, parking management system 104 may determine that the third vehicle is assigned to a different parking space. For example, parking management system 104 may determine that the third vehicle is assigned to a different parking space based on parking management system 104 comparing the license plate identifier associated with the license plate of the third vehicle included in an image to identifiers associated with license plates of vehicles assigned to parking spaces of the facility associated with the facility parking schedule. In some non-limiting embodiments or aspects, parking management system 104 may determine a parking space different from the parking space that the third vehicle is in. For example, parking management system 104 may determine a parking space different from the parking space that the third vehicle is in based on parking management system 104 determining that the third vehicle is assigned to a different parking space. In such an example, parking management system 104 may associate the first vehicle with a second parking space different from the first parking space during a period of time. In this example, the period of time may correspond to a period of time the third vehicle is associated with a parking space included in the facility (e.g., a parking space that was assigned to the third vehicle).

In some non-limiting embodiments or aspects, parking management system 104 may transmit data associated with an indication that the second parking space is associated with the first vehicle. For example, parking management system 104 may transmit data associated with an indication that the second parking space is associated with the first vehicle based on parking management system 104 determining the parking space different from the parking space that the third vehicle is in (e.g., a parking space different from the first parking space). In such an example, the data associated with the indication that the second parking space is associated with the first vehicle may be configured to cause user device 102 associated with the first vehicle to generate a display including the indication (e.g., the identifier associated with the second parking space) that the second parking space is associated with the first vehicle during a period of time (e.g., the period of time that the first vehicle was assigned to the first parking space).

In some non-limiting embodiments or aspects, parking management system 104 may determine a parking space different from the parking space that the third vehicle is in, where the parking space different from the parking space that the third vehicle is in is located at a different facility. For example, parking management system 104 may determine a parking space different from the parking space that the third vehicle is in based on parking management system 104 determining that the facility including the parking space that the third vehicle is in does not include another parking space that may be assigned to the first vehicle. In some non-limiting embodiments or aspects, parking management system 104 may transmit data associated with the parking space different from the parking space that the third vehicle is in. For example, parking management system 104 may transmit data associated with the parking space different from the parking space that the third vehicle is in, where the data associated with the parking space different from the parking space that the third vehicle is in is configured to cause user device 102 to display an indication that the parking space different from the parking space that the third vehicle is in is available as a substitute for the first parking space. In such an example, user device 102 may receive input including an indication of whether the parking space different from the parking space that the third vehicle is in is accepted or not accepted based on user device 102 displaying the indication that the parking space different from the parking space that the third vehicle is in is available as a substitute parking space. User device 102 may generate and transmit data associated with the indication of whether the parking space different from the parking space that the third vehicle is in is accepted or not accepted.

In some non-limiting embodiments or aspects, parking management system 104 may generate data associated with a transaction based on the indication of whether the parking space different from the parking space that the third vehicle is in is accepted or not accepted. For example, parking management system 104 may generate data associated with a transaction, where the transaction is associated with a refund. In such an example, parking management system 104 may transmit the data associated with the transaction, where the transaction is associated with the refund, to initiate the transaction. Additionally, or alternatively, parking management system 104 may forego generating data associated with a transaction based on the indication of whether the parking space different from the parking space that the third vehicle is in is accepted or not accepted. For example, parking management system 104 may receive an indication that the parking space different from the parking space that the third vehicle is in is not accepted and parking management system 104 may forego generating data associated with a transaction at a later time. In such an example, parking management system 104 may associate a parking space with the first vehicle during the later time (e.g., a time after period of time the time during which the third vehicle is located in the first parking space) and parking management system 104 may forego generating the data associated with a transaction during the later time.

In some non-limiting embodiments or aspects, parking management system 104 may determine that a parking violation exists. For example, parking management system 104 may determine that a parking violation exists (e.g., that a vehicle is in a parking space having an identifier that is not assigned to the vehicle) based on parking management system 104 determining that a vehicle (e.g., the third vehicle, discussed above) is assigned to a different parking space and/or that the vehicle is not assigned to a parking space. In some non-limiting embodiments or aspects, parking management system 104 may determine that a parking violation exists and parking management system 104 may generate data associated with a transaction based on the parking violation. For example, parking management system 104 may determine that the parking violation exists and parking management system 104 may generate data associated with a transaction, where the transaction is associated with a fee for parking in a parking space not assigned to the vehicle parked in the parking space. In some non-limiting embodiments or aspects, parking management system 104 may determine that the parking violation exists and parking management system 104 may generate data associated with an indication that the parking violation exists. For example, parking management system 104 may generate data associated with an indication that the parking violation exists where the data is configured to cause a display device of parking management system 104 to generate a display including the indication that the parking violation exists.

In some non-limiting embodiments or aspects, parking management system 104 may forego confirming a parking schedule. For example, parking management system 104 may forego confirming a parking schedule based on parking management system 104 determining that user device 102 associated with the parking schedule was involved in one or more parking violations. In such an example, the one or more parking violations may include a predetermined number of parking violations (e.g., three parking violations). In some non-limiting embodiments or aspects, parking management system 104 may later confirm the parking schedule based on parking management system 104 determining that a transaction was processed where the transaction is associated with (e.g., generated based on) the one or more parking violations.

In some non-limiting embodiments or aspects, parking management system 104 may determine whether a vehicle is located at a facility. For example, parking management system 104 may determine whether the first vehicle is located at a facility based on parking management system 104 determining a location of user device 102 associated with the first vehicle is located within an area associated with the facility (e.g., the facility, an area including the facility and a predetermined distance (e.g., 0.1 miles from a border of the facility, and/or the like). In such an example, parking management system 104 determining a location of user device 102 based on user device 102 transmitting data associate with the location of user device 102 to parking management system 104. In an example, user device 102 may determine the data associated with the location of user device 102 generated via a GPS receiver included in user device 102 and user device 102 may transmit the data associated with the location of user device 102 to parking management system 104. Additionally, or alternatively, parking management system 104 may determine whether a vehicle is located at the facility at a time (e.g., at a point in time, during a period of time, and/or the like). For example, parking management system 104 may determine whether the first vehicle is located at the facility at a time during which the first vehicle is assigned to a parking space. In such an example, parking management system 104 may determine whether the first vehicle is located at the facility at a time during which the first vehicle is assigned to a parking space based on data associated with a timestamp transmitted to parking management system 104 by user device 102. User device 102 may transmit the data associated with a timestamp to parking management system 104 separately or with the data associated with the location of user device 102 to parking management system 104.

In some non-limiting embodiments or aspects, parking management system 104 may determine whether to identify a vehicle associated with a parking space as checked-in (e.g., as in or within a predetermined distance from the parking space and/or the facility including the parking space) or checked-out (e.g., as not in or near the parking space and/or the facility including the parking space). For example, parking management system 104 may determine whether to identify a vehicle associated with a parking space as checked-in or checked-out based on the data associated with user device 102. During checking-in and/or checking-out, parking management system 104 and user device 102 may communicate via applications executed on each device, respectively. In some non-limiting embodiments or aspects, parking management system 104 may determine that one or more criteria for checking-in a vehicle are satisfied. In some non-limiting embodiments or aspects, one or more criteria for checking-in a vehicle may include the vehicle being in or near the in or within a predetermined distance (e.g., 0.1 miles, 0.3 miles, and/or the like) from the parking space and/or the facility including the parking space, the time at which the vehicle was determined to be in or within a predetermined distance from the parking space and/or the facility including the parking space being within a range of times (e.g., up to fifteen minutes before the time associated with the parking schedule, up to thirty minutes before the time associated with the parking schedule, up to fifteen minutes after the time associated with the parking schedule, up to thirty minutes after the time associated with the parking schedule and/or the like). In some non-limiting embodiments or aspects, parking management system 104 may determine that one or more criteria for checking-out the vehicle are satisfied. In some non-limiting embodiments or aspects, one or more criteria for checking-out the vehicle may include the vehicle being outside or within a predetermined distance (e.g., 0.1 miles) from the parking space and/or the facility including the parking space, the time at which the vehicle was determined to be outside or within a predetermined distance from the parking space and/or the facility including the parking space being within a range of times (e.g., the point in time at the end of the time associated with the parking schedule, up to fifteen minutes after the time associated with the parking schedule, up to thirty minutes after the time associated with the parking schedule and/or the like). In some non-limiting embodiments or aspects, parking management system 104 may generate data associated with a transaction based on parking management system 104 determining whether to identify a vehicle associated with a parking space as checked-in or checked-out. For example, parking management system 104 may generate data associated with a transaction based on parking management system 104 determining that the vehicle was checked-in before the time associated with the parking schedule. Additionally, or alternatively, parking management system 104 may generate data associated with a transaction based on parking management system 104 determining that the vehicle was checked-out after the time associated with the parking schedule. In such examples, the transaction may include a transaction associated with a fee for checking-in early (e.g., at a time before a time specified by the parking schedule and/or checking-out late (e.g., at a time after a time specified by the parking schedule). Additionally, or alternatively, the transaction may include a transaction associated with a fee for foregoing checking-in and/or checking-out. In some non-limiting embodiments or aspects, parking management system 104 may transmit data associated with an indication that a time associated with a parking schedule will begin or expire within a period of time. For example, parking management system 104 may transmit data associated with an indication that a time associated with a parking schedule will begin within a period of time to user device 102 associated with the parking schedule. In another example, parking management system 104 may transmit data associated with an indication that a time associated with a parking schedule will expire within a period of time to user device 102 associated with the parking schedule. In such examples, the data may be configured to cause user device 102 to display the indication that the time associated with the parking schedule will begin or expire with the period of time. In some non-limiting embodiments or aspects, user device 102 may receive input via an input device of user device 102 indicating that the vehicle is checked-in or checked-out. For example, user device 102 may receive input via an input device of user device 102 indicating that the vehicle is checked-in or checked-out and user device 102 may transmit data associated with the indication that the vehicle is checked-in or checked-out to parking management system 104. In some non-limiting embodiments or aspects, parking management system 104 may determine whether to check-in or check-out the vehicle based on the indication that the vehicle is checked-in or checked-out. Additionally, or alternatively, parking management system 104 may determine whether to forego checking-in or checking-out the vehicle. For example, parking management system 104 may determine whether to forego checking-out the vehicle based on parking management system 104 determining that user device 102 is located a distance from the facility that is greater than a predetermined distance (e.g., a distance greater than 0.5 miles, a distance greater than one mile, and/or the like).

In some non-limiting embodiments or aspects, parking management system 104 may transmit data associated with a notification to extend a parking schedule. For example, parking management system 104 may transmit data associated with a notification to extend a parking schedule to user device 102. In such an example, parking management system 104 may transmit the data associated with the notification to extend the parking schedule to user device 102 after a period of time has passed after the vehicle was to be checked-out (e.g., fifteen minutes after the period of time has passed, thirty minutes after the period of time has passed, and/or the like). In some non-limiting embodiments or aspects, parking management system 104 may determine whether extending the parking schedule associated with a vehicle will conflict with a parking schedule associated with another vehicle. For example, parking management system 104 may determine whether extending the parking schedule associated with a vehicle will conflict with a parking schedule associated with another vehicle based on parking management system 104 determining whether the parking space associated with the vehicle is available at a time and parking management system 104 comparing the time to a time that the parking space will be associated with the another vehicle. In some non-limiting embodiments or aspects, parking management system 104 may forego transmitting the notification to extend the parking schedule associated with the vehicle based on parking management system 104 determining that the parking space will be associated with another vehicle. In some non-limiting embodiments or aspects, parking management system 104 may transmit the data associated with the notification to extend the parking schedule to user device 102 to cause user device 102 to display the notification to extend the parking schedule. For example, parking management system 104 may transmit the data associated with the notification to extend the parking schedule to user device 102 to cause user device 102 to display the notification to extend the parking schedule via a display of user device 102. In some non-limiting embodiments or aspects, user device 102 may receive input indicating that the parking schedule should be extended. For example, user device 102 may receive input indicating that the parking schedule should be extended for a period of time. In such an example, user device 102 may generate data associated with the indication that the parking schedule should be extended and user device 102 may transmit the data associated with the indication that the parking schedule should be extended to parking management system 104. Additionally, or alternatively, user device 102 may receive input indicating that the parking schedule should not be extended. For example, user device 102 may receive input indicating that the parking schedule should not be extended for the period of time. In such an example, user device 102 may generate data associated with the indication that the parking schedule should not be extended and user device 102 may transmit the data associated with the indication that the parking schedule should not be extended to parking management system 104. In some non-limiting embodiments or aspects, parking management system 104 may generate data associated with a transaction based on the data associated with the indication of whether the parking schedule should be extended or should not be extended. For example, the transaction may include a transaction associated with a fee for extending the parking schedule. Additionally, or alternatively, the transaction may include a transaction associated with a fee for foregoing extending the parking schedule. In some non-limiting embodiments or aspects, parking management system 104 may generate the data associated with the transaction after a period of time has elapsed. For example, parking management system 104 may generate the data associated with the transaction after a period of time has elapsed (e.g., after a period of time has elapsed starting when the vehicle was expected to be checked-out).

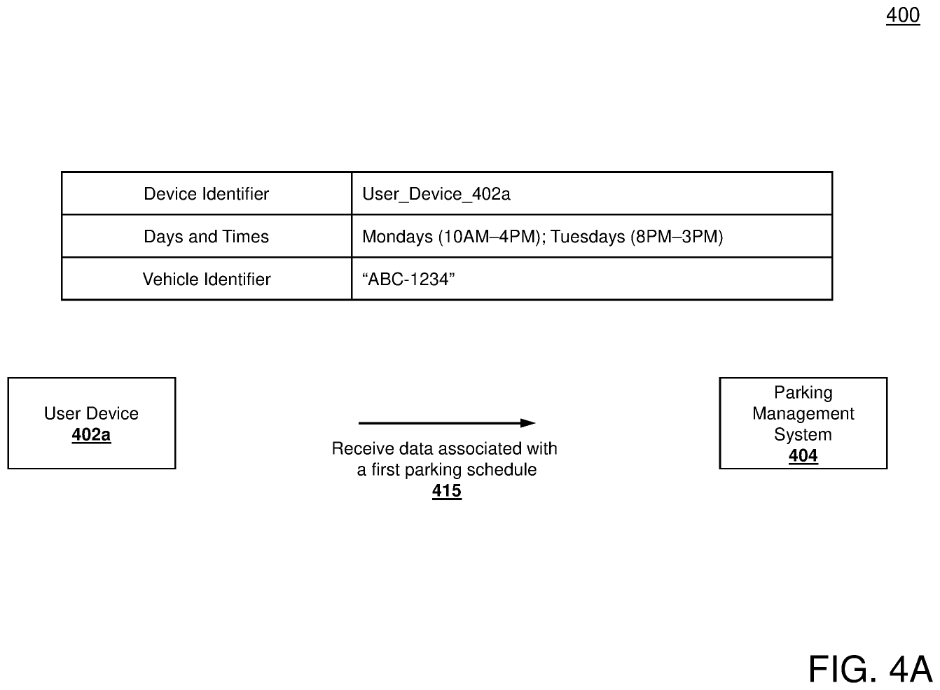

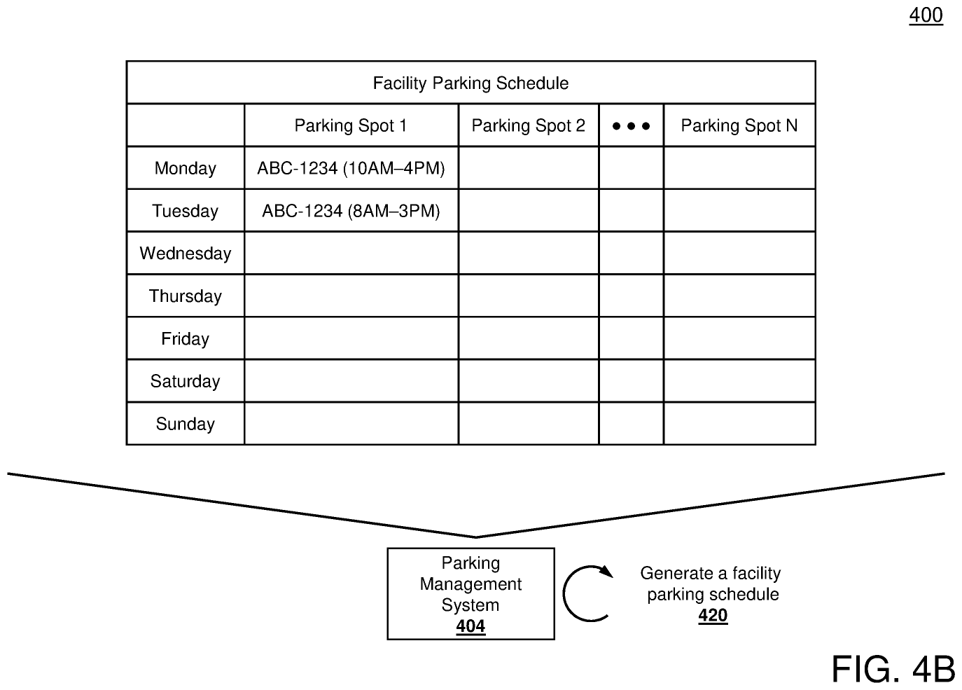

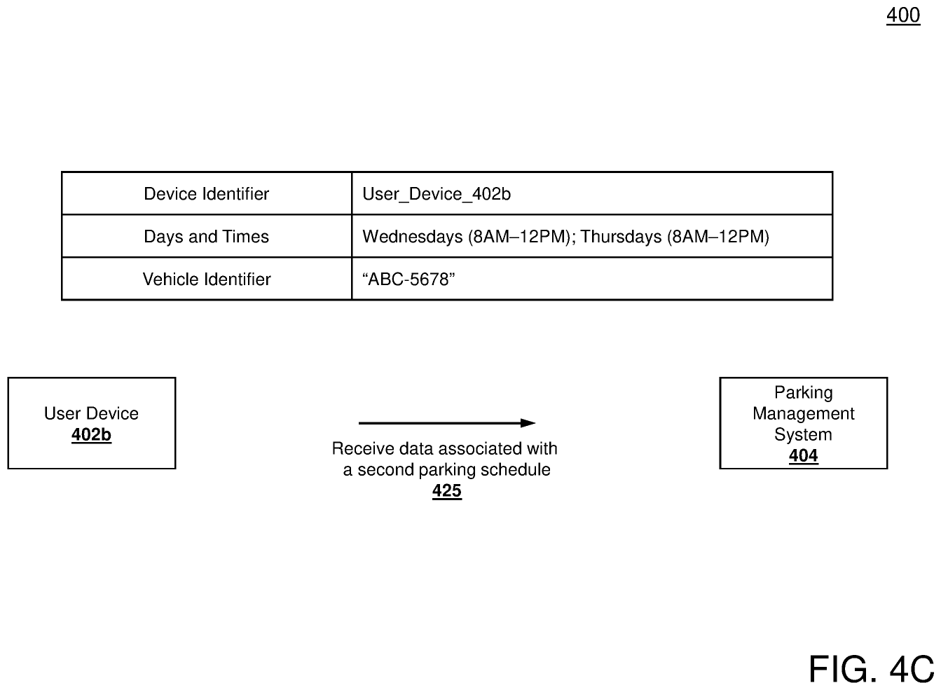

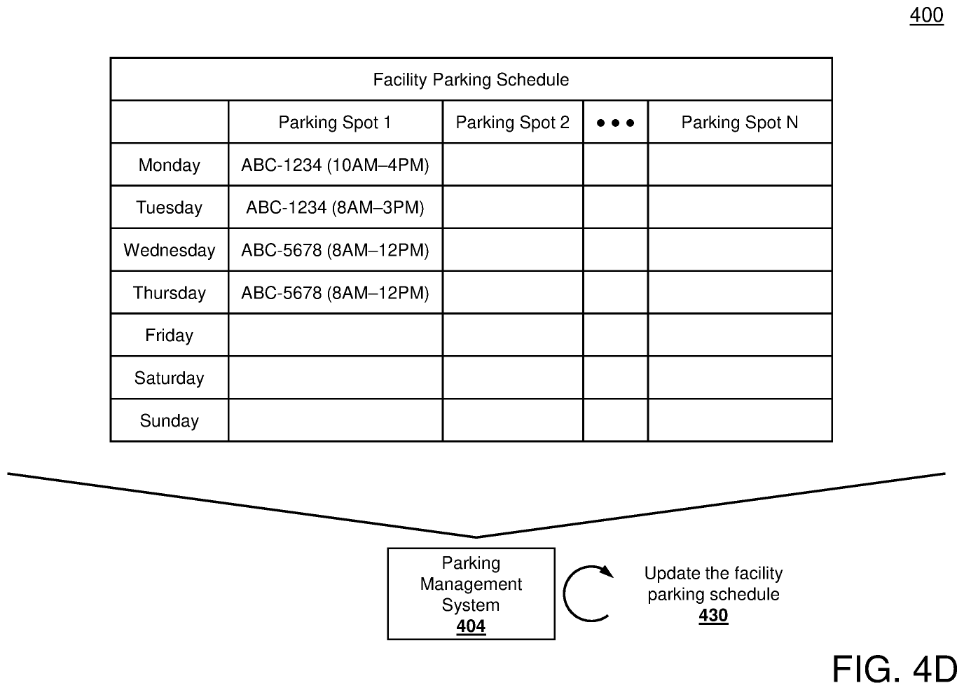

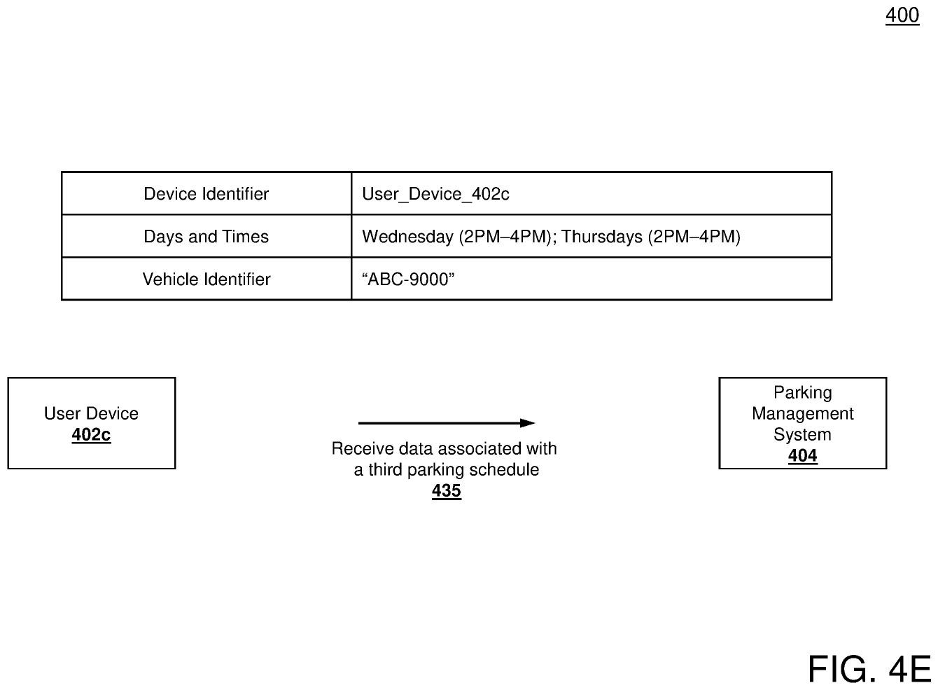

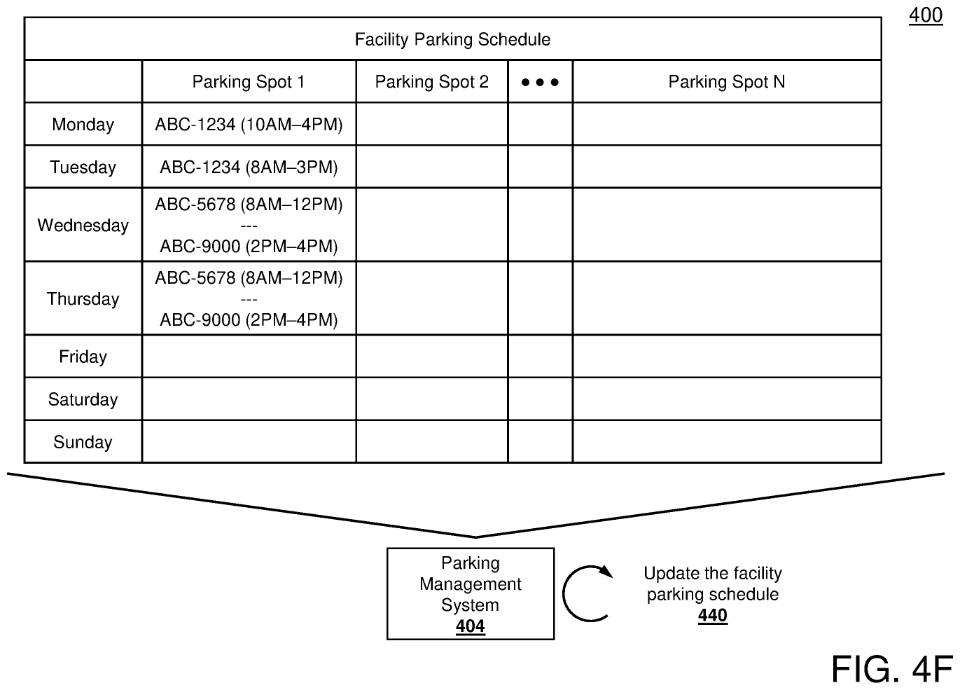

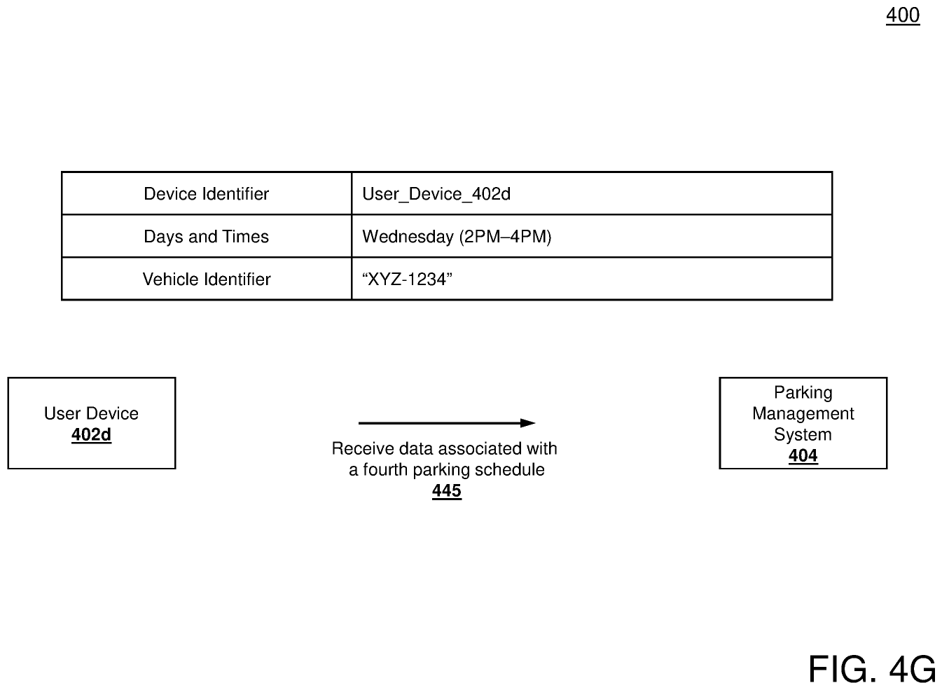

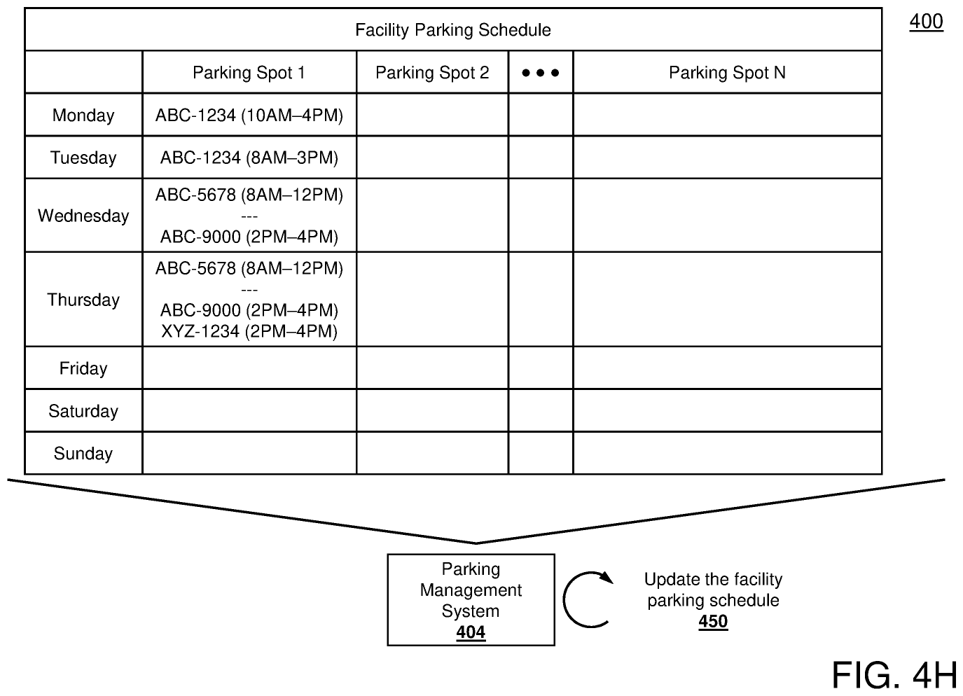

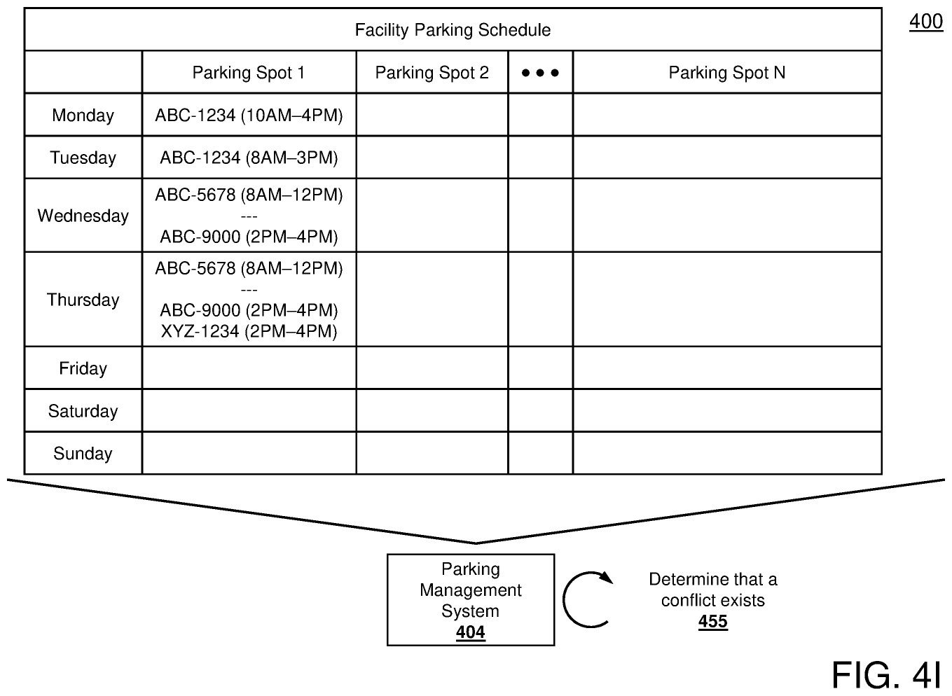

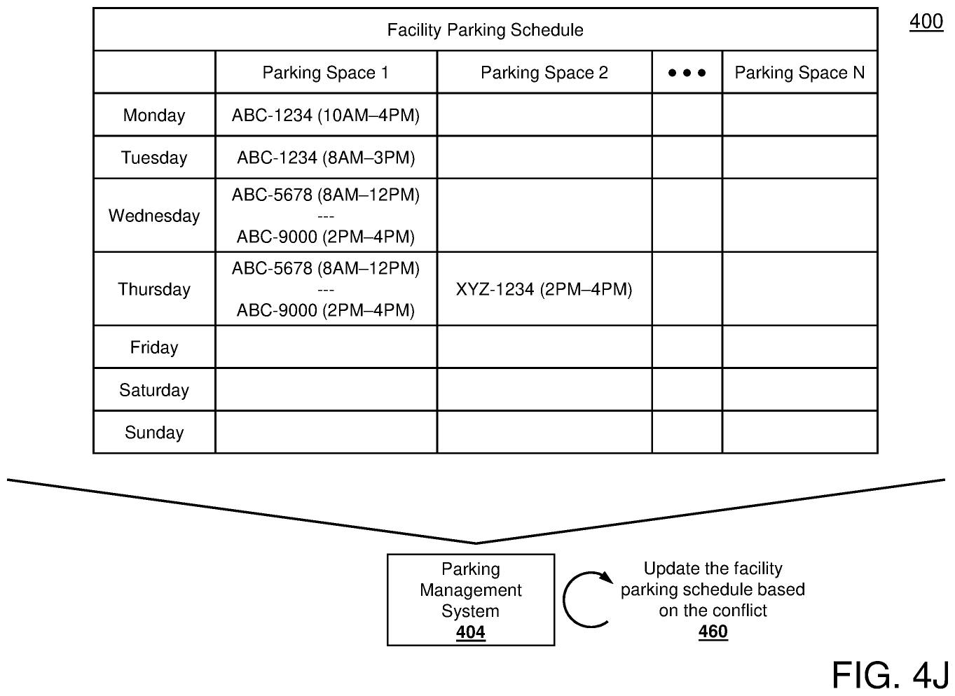

Referring now to FIGS. 4A-4J, FIG. 4A-4J are flowcharts of a non-limiting embodiment or aspect of an implementation 400 relating to a process for determining a parking schedule. As illustrated in FIGS. 4A-4J, implementation 400 may include user device 402a, user device 402b, user device 402c, user device 402d, and parking management system 404. In some non-limiting embodiments or aspects, user device 402a, user device 402b, user device 402c, user device 402d may be the same as or similar to user device 102. In some non-limiting embodiments or aspects, parking management system 404 may be the same as or similar to parking management system 104.

As shown by reference number 415 in FIG. 4A, parking management system 404 may receive data associated with a first parking schedule from user device 402a. The first parking schedule may include data associated with a device identifier of user device 402a (“User_Device_402a”), data associated with days and times during which a vehicle is to be parked in a parking space in a parking facility (e.g., Mondays (10 AM-4 PM); Tuesdays (8 PM-3 PM)), and/or a vehicle identifier associated with user device 102b (“ABC-1234”).

As shown by reference number 420 in FIG. 4B, parking management system 404 may generate a facility parking schedule for a parking facility. For example, parking management system 404 may generate a facility parking schedule for a parking facility based on the data associated with the first parking schedule. In such an example, the facility parking schedule may include data associated with one or more parking spots (e.g., Parking Spot 1, Parking Spot 2, . . . Parking Spot N). In some non-limiting embodiments or aspects, parking management system 404 may generate data associated with a transaction based on the facility parking schedule. For example, parking management system 404 may generate data associated with a transaction based on the facility parking schedule (e.g., a transaction with a fee of $300 for a month associated with parking management system 404 associating the first vehicle with Parking Spot 1).

As shown by reference number 425 in FIG. 4C, parking management system 404 may receive data associated with a second parking schedule from user device 402b. The second parking schedule may include data associated with a device identifier of user device 402b (“User_Device_402b”), data associated with days and times during which a vehicle is to be parked in a parking space in a parking facility (e.g., Wednesdays (8 AM-12 PM); Thursdays (8 AM-12 PM)), and/or a vehicle identifier associated with user device 102b (“ABC-5678”).

As shown by reference number 430 in FIG. 4D, parking management system 404 may update the facility parking schedule for the parking facility. For example, parking management system 404 may update the facility parking schedule for a parking facility based on the second parking schedule. In some non-limiting embodiments or aspects, parking management system 404 may generate data associated with a transaction based on the facility parking schedule. For example, parking management system 404 may generate data associated with a transaction based on the facility parking schedule (e.g., a transaction with a fee of $300 for a month associated with parking management system 404 associating the second vehicle with Parking Spot 1).

As shown by reference number 435 in FIG. 4E, parking management system 404 may receive data associated with a third parking schedule from user device 402c. The third parking schedule may include data associated with a device identifier of user device 402c (“User_Device_402c”), data associated with days and times during which a vehicle is to be parked in a parking space in a parking facility (e.g., Wednesday (2 PM-4 PM); Thursdays (2 PM-4 PM)), and/or a vehicle identifier associated with user device 102b (“ABC-9000”).

As shown by reference number 440 in FIG. 4F, parking management system 404 may update the facility parking schedule for the parking facility. For example, parking management system 404 may update the facility parking schedule for a parking facility based on the third parking schedule. In some non-limiting embodiments or aspects, parking management system 404 may generate data associated with a transaction based on the facility parking schedule. For example, parking management system 404 may generate data associated with a transaction based on the facility parking schedule (e.g., a transaction with a fee of $300 for a month associated with parking management system 404 associating the third vehicle with Parking Spot 1).

As shown by reference number 445 in FIG. 4G, parking management system 404 may receive data associated with a fourth parking schedule from user device 402d. The fourth parking schedule may include data associated with a device identifier of user device 402d (“User_Device_402d”), data associated with days and times during which a vehicle is to be parked in a parking space in a parking facility (e.g., Wednesday (2 PM-4 PM)), and/or a vehicle identifier associated with user device 102b (“XYZ-1234”).

As shown by reference number 450 in FIG. 4H, parking management system 404 may update the facility parking schedule for the parking facility. For example, parking management system 404 may update the facility parking schedule for a parking facility based on the fourth parking schedule.

As shown by reference number 455 in FIG. 41, parking management system 404 may determine that a conflict exists. For example, parking management system 404 may determine that a conflict exists between the third parking schedule and the fourth parking schedule. In such an example, parking management system 404 may determine that the third vehicle (associated with identifier “ABC-9000”) is scheduled to park in a parking spot (“Parking Spot 1”) and the fourth vehicle (associated with identifier “XYZ-1234”) is scheduled to park in a parking spot (“Parking Spot 1”).

As shown by reference number 460 in FIG. 4J, parking management system 404 may update the facility parking schedule based on the conflict. For example, parking management system 404 may update the facility parking schedule by reassigning the fourth vehicle to a different parking space (“Parking Space 2”). In some non-limiting embodiments or aspects, parking management system 404 may generate data associated with a transaction based on the facility parking schedule. For example, parking management system 404 may generate data associated with a transaction based on the facility parking schedule (e.g., a transaction with a fee of $300 for a month associated with parking management system 404 associating the fourth vehicle with Parking Spot 2).

Although the above methods, systems, and computer program products have been described in detail for the purpose of illustration based on what is currently considered to be the most practical and preferred embodiments or aspects, it is to be understood that such detail is solely for that purpose and that the present disclosure is not limited to the described embodiments or aspects but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method, comprising:
receiving, with at least one processor, data associated with a first parking schedule involving a first vehicle;
generating, with at least one processor, a facility parking schedule based on the first parking schedule and one or more identifiers corresponding to one or more parking spaces in a parking garage;
receiving, with at least one processor, data associated with a second parking schedule involving a second vehicle different from the first vehicle;
comparing, with at least one processor, one or more times associated with the facility parking schedule that involve the first parking schedule with one or more times associated with the facility parking schedule that involve the second parking schedule;
determining, with at least one processor, whether a conflict exists based on comparing the one or more times associated with the facility parking schedule that involve the first parking schedule with the one or more times associated with the facility parking schedule that involve the second parking schedule; and
updating, with at least one processor, the facility parking schedule based on the conflict, wherein updating the facility parking schedule includes associating the first vehicle with an identifier corresponding to a parking space that is different from an identifier of a parking space that is associated with the first vehicle by the facility parking schedule.

2. The computer-implemented method of claim 1, wherein determining whether a conflict exists based on the first parking schedule and the second parking schedule comprises:
determining that one or more conflicts exist based on the first parking schedule and the second parking schedule,
the method further comprising:
generating data associated with a transaction based on the first parking schedule and the one or more conflicts that exist; and
transmitting the data to initiate the transaction.

3. The computer-implemented method of claim 1, further comprising:
receiving data associated with an image of a license plate in a parking space;
determining a license plate identifier based on the image of the license plate in the parking space using an image processing algorithm and a time at which the image of the license plate was captured;
comparing the license plate identifier to one or more license plate identifiers associated with the facility parking schedule at the time at which the image of the license plate was captured; and
determining whether a parking violation exists based on comparing the license plate identifier to the one or more license plate identifiers associated with the facility parking schedule at the time at which the image of the license plate was captured.

4. The computer-implemented method of claim 3, wherein determining whether a parking violation exists based on comparing the license plate identifier to the one or more license plate identifiers associated with the facility parking schedule at the time at which the image of the license plate was captured comprises:
determining that the parking violation exists based on comparing the license plate identifier to the one or more license plate identifiers associated with the facility parking schedule at the time at which the image of the license plate was captured,
the method further comprising:
transmitting data associated with a transaction generated based on the parking violation, the data associated with the transaction configured to cause a user device associated with the transaction to generate a display indicating that the transaction is pending.

5. The computer-implemented method of claim 1, further comprising:
determining that the first vehicle is parked in a parking space at a time other than a time specified by the first parking schedule; and
generating data associated with a transaction based on determining that the first vehicle is parked in a parking space at a time other than a time specified by the first parking schedule, the data associated with the transaction configured to cause a user device associated with the transaction to generate a display indicating that the transaction is pending.

6. The computer-implemented method of claim 1, further comprising:
receiving data associated with an indication that a third vehicle is in a parking space associated with the first vehicle;
determining a second parking space different from the parking space that the third vehicle is parked in;
associating the second parking space with the first vehicle during a period of time; and
transmitting data associated with an indication that the second parking space is associated with the first vehicle during the period of time, wherein the data associated with the indication that the second parking space is associated with the first vehicle during the period of time is configured to cause a user device associated with the first vehicle to generate a display including the indication that the second parking space is associated with the first vehicle during the period of time.

7. The computer-implemented method of claim 1, further comprising:
receiving data associated with an indication that a third vehicle is in a parking space associated with a first vehicle;
determining that a parking violation exists based on the indication that the third vehicle is in the parking space associated with the first vehicle; and
generating data associated with a transaction based on the parking violation.

8. A system, comprising:
at least one processor programmed or configured to:
receive data associated with a first parking schedule involving a first vehicle;
generate a facility parking schedule based on the first parking schedule and one or more identifiers corresponding to one or more parking spaces in a parking garage;
receive data associated with a second parking schedule involving a second vehicle different from the first vehicle; and
determine whether a conflict exists based on the facility parking schedule and the second parking schedule.

9. The system of claim 8, wherein determining whether a conflict exists based on the facility parking schedule and the second parking schedule comprises:
comparing one or more times associated with the facility parking schedule with one or more times associated with the second parking schedule to determine whether the conflict exists.

10. The system of claim 8, wherein, when determining whether a conflict exists based on the first parking schedule and the second parking schedule, the at least one processor is programmed or configured to:
determine that one or more conflicts exist based on the first parking schedule and the second parking schedule,
wherein the at least one processor is further programmed or configured to:
generate data associated with a transaction based on the first parking schedule and the one or more conflicts that exist; and
transmit the data to initiate the transaction.

11. The system of claim 8, wherein the at least one processor is further programmed or configured to:
receive data associated with an image of a license plate in a parking space;
determine a license plate identifier based on the image of the license plate in the parking space using an image processing algorithm and a time at which the image of the license plate was captured;
compare the license plate identifier to one or more license plate identifiers associated with the facility parking schedule at the time at which the image of the license plate was captured; and
determine whether a parking violation exists based on comparing the license plate identifier to the one or more license plate identifiers associated with the facility parking schedule at the time at which the image of the license plate was captured.

12. The system of claim 11, wherein, when determining whether a parking violation exists based on comparing the license plate identifier to the one or more license plate identifiers associated with the facility parking schedule at the time at which the image of the license plate was captured, the at least one processor is programmed or configured to:
determine that the parking violation exists based on comparing the license plate identifier to the one or more license plate identifiers associated with the facility parking schedule at the time at which the image of the license plate was captured,
wherein the at least one processor is further programmed or configured to:
transmit data associated with a transaction generated based on the parking violation, the data associated with the transaction configured to cause a user device associated with the transaction to generate a display indicating that the transaction is pending.

13. The system of claim 8, wherein the at least one processor is further programmed or configured to:
determine that the first vehicle is parked in a parking space at a time other than a time specified by the first parking schedule; and
generate data associated with a transaction based on determining that the first vehicle is parked in a parking space at a time other than a time specified by the first parking schedule, the data associated with the transaction configured to cause a user device associated with the transaction to generate a display indicating that the transaction is pending.

14. The system of claim 8, wherein the at least one processor is further programmed or configured to:
receive data associated with an indication that a third vehicle is in a parking space associated with the first vehicle;
determine a second parking space different from the parking space that the third vehicle is parked in;
associate the second parking space with the first vehicle during a period of time; and
transmit data associated with an indication that the second parking space is associated with the first vehicle during the period of time, wherein the data associated with the indication that the second parking space is associated with the first vehicle during the period of time is configured to cause a user device associated with the first vehicle to generate a display including the indication that the second parking space is associated with the first vehicle during the period of time.

15. A computer program product, comprising at least one non-transitory computer-readable medium including program instructions that, when executed by at least one processor, cause the at least one processor to:
receive data associated with a first parking schedule involving a first vehicle;
generate a facility parking schedule based on the first parking schedule and one or more identifiers corresponding to one or more parking spaces in a parking garage;
receive data associated with a second parking schedule involving a second vehicle different from the first vehicle; and
determine whether a conflict exists based on the facility parking schedule and the second parking schedule.

16. The computer program product of claim 15, wherein the one or more instructions that cause the at least one processor to determine whether a conflict exists based on the facility parking schedule and the second parking schedule cause the at least one processor to:
compare one or more times associated with the facility parking schedule with one or more times associated with the second parking schedule to determine whether the conflict exists.

17. The computer program product of claim 15, wherein the one or more instructions that cause the at least one processor to determine whether a conflict exists based on the first parking schedule and the second parking schedule cause the at least one processor to:
determine that one or more conflicts exist based on the first parking schedule and the second parking schedule,
wherein the one or more instructions further cause the at least one processor to:
generate data associated with a transaction based on the first parking schedule and the one or more conflicts that exist; and
transmit the data to initiate the transaction.

18. The computer program product of claim 15, wherein the one or more instructions further cause the at least one processor to:
receive data associated with an image of a license plate in a parking space;
determine a license plate identifier based on the image of the license plate in the parking space using an image processing algorithm and a time at which the image of the license plate was captured;
compare the license plate identifier to one or more license plate identifiers associated with the facility parking schedule at the time at which the image of the license plate was captured; and
determine whether a parking violation exists based on comparing the license plate identifier to the one or more license plate identifiers associated with the facility parking schedule at the time at which the image of the license plate was captured.

19. The computer program product of claim 18, wherein the one or more instructions that cause the at least one processor to determine whether a parking violation exists based on comparing the license plate identifier to the one or more license plate identifiers associated with the facility parking schedule at the time at which the image of the license plate was captured cause the at least one processor to:
determine that the parking violation exists based on comparing the license plate identifier to the one or more license plate identifiers associated with the facility parking schedule at the time at which the image of the license plate was captured,
wherein the one or more instructions further cause the at least one processor to:
transmit data associated with a transaction generated based on the parking violation, the data associated with the transaction configured to cause a user device associated with the transaction to generate a display indicating that the transaction is pending.

20. The computer program product of claim 15, wherein the one or more instructions further cause the at least one processor to:
determine that the first vehicle is parked in a parking space at a time other than a time specified by the first parking schedule; and
generate data associated with a transaction based on determining that the first vehicle is parked in a parking space at a time other than a time specified by the first parking schedule, the data associated with the transaction configured to cause a user device associated with the transaction to generate a display indicating that the transaction is pending.
